(19) United States
(12) Patent Application Publication
(10) Pub. No.: US 2022/0258067 A1
(43) Pub. Date: Aug. 18, 2022

(54) Continuous-Feed Vacuum System with Integrated Degasser

(71) Applicant: Jared Carver, South Hadley, MA (US)

(72) Inventor: Jared Carver, South Hadley, MA (US)

(21) Appl. No.: 17/803,095

(22) Filed: Feb. 4, 2022

Related U.S. Application Data
(60) Provisional application No. 63/207,049, filed on Feb. 6, 2021.

(51) Int. Cl. B01D 3/10; B01D 3/12; B01D 19/00

(52) U.S. Cl. CPC B01D 3/10; B01D 3/12; B01D 19/0073; B01D 19/0052; B01D 19/0036

(57) ABSTRACT

A continuous-feed vacuum distillation system with an integrated degasser is proposed. The degasser uses the same or a different vacuum system as the downstream distillation column and operates continuously on the material to be distilled before it enters the distillation column. This eliminates the current practices of degassing the feed material in bulk, with auxiliary equipment, before it enters the distillation apparatus, a difficult and time-consuming procedure, or using the distillation system in a low temperature state under vacuum, to remove the gas from the feed material, which is also inefficient. Various alternative features of the claimed integrated degasser are also claimed.

### CROSS-REFERENCE TO RELATED APPLICATIONS

This application claims the priority date of U.S. provisional patent application U.S. 63/207,049, filed Feb. 6, 2021.

### STATEMENT REGARDING FEDERALLY SPONSORED RESEARCH OR

DEVELOPMENT

The subject matter of this application is unrelated to any federally sponsored research or development.

### BACKGROUND OF THE INVENTION

This invention pertains to apparatuses for molecular distillation of fluids. Apparatuses for molecular distillation are well known, see, e.g., Burrows, Molecular Distillation (1960), and may be either batch or continuous in nature. In continuous distillation apparatuses, a liquid feed material is fed continuously into the distillation apparatus where it is heated in a distillation column, thereby separating the constituents of the feed material so that the more valuable constituents may be captured and utilized. If gases are entrained in the feed material when it reaches the distillation column, the efficiency of the distillation process may be reduced significantly. In common practice, gases are sometimes removed from the bulk feed material in equipment auxiliary to the distillation apparatus, with the risk that additional gases will be absorbed by the feed material after degassing but before distillation. Another common approach to degassing is to process the feed material through the distillation column at low temperature to remove the gases from the feed material. By occupying the distillation column for this suboptimal application, this approach at least doubles the time required to process a given amount of feed material.

### BRIEF SUMMARY OF THE INVENTION

The invention proposed is a degasser integrated with the continuous-feed molecular distillation apparatus, which degasser receives and degasses the feed material on a continuous basis as it enters the apparatus and before it reaches the distillation column. The integrated degasser eliminates the need for auxiliary degassing equipment. Because the feed material is degassed immediately before entering the distillation column, the integrated degasser also eliminates the risk of regasification inherent in the use of auxiliary degassing equipment. It also avoids the sub-optimal use of the distillation column itself as a degasifier.

### BRIEF DESCRIPTION OF THE DRAWINGS

FIG. 1 is a process diagram of a continuous-feed vacuum distillation system including an integrated degasser unit in accordance with one embodiment of the current invention.

FIG. 2 is a degasser vessel in accordance with one embodiment of this invention.

FIG. 3 is a process diagram of a continuous-feed vacuum distillation system including integrated preheater vessel and degasser unit in accordance with another embodiment of the invention.

### DETAILED DESCRIPTION OF THE INVENTION

Vacuum distillation systems are well known. They consist essentially of a distillation column and a means of evacuating gases from the column to create a vacuum in the distillation column. In a continuous-feed vacuum distillation system, a liquid feed material is introduced continuously into the distillation column, where it is heated to vaporize selected constituents of the feed material. These vaporized constituents are then recondensed on condensation surfaces located either inside the distillation column (short path) or outside the column, thus effecting the desired separation. These vaporized and condensed materials and the unvaporized residual feed material are segregated into separate streams and collected. The distillation column in such a system may be of any of numerous well-known designs embodying well-known design considerations, as explained in existing literature. Typically a vacuum pump is used to create the vacuum in the distillation column. The type of pump is known to those that are familiar with vacuum distillation.

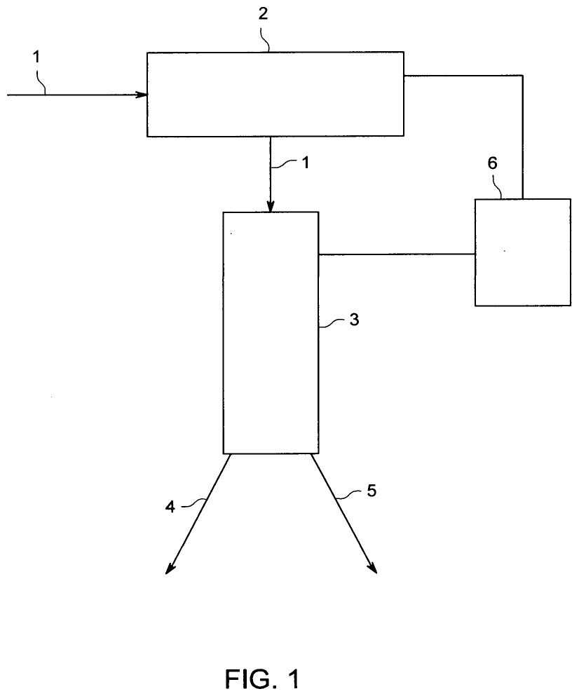

In one embodiment, the invention consists of a continuous-feed vacuum distillation system into which a degassing unit has been integrated, as shown in FIG. 1. Feed material 1 flows through the degassing unit 2, then enters the distillation column 3, where it is separated into a distillate stream 4 and a residue stream 5. A vacuum pump 6 is connected to both the degassing unit and the distillation column, so that both operate under vacuum.

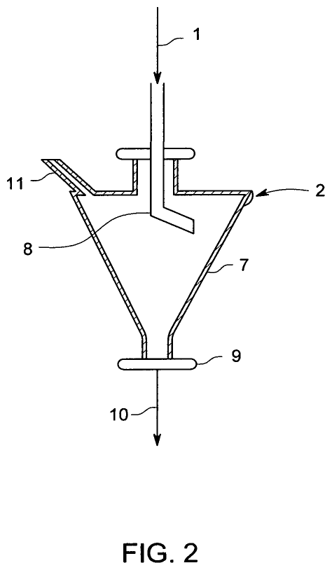

The degassing unit in this embodiment FIG. 2 comprises a vessel 7 into which feed material 1 flows through an inlet connection 8, an outlet connection 9 for the degassed feed material 10 to exit the degasser, and a port 11 for connection of the vessel to a vacuum pump. The vessel is constructed of any suitable material rated for vacuum service, preferably of stainless steel, aluminum, or glass, and is of a volume and dimensions sufficient to accommodate the flow rate mentioned below. It is especially important to create within the vessel a surface area of feed material that, consistent with the flowrate through the vessel, will permit the desired degasification of the feed material. By analysis and experimentation, it has been found by the inventor that a vessel that creates a feed material surface area of 530 square centimeters permits complete degasification at flowrates up to [22] liters per hour. The degasification vessel 2 is installed in the distillation system upstream of the distillation column 3, as shown in FIG. 1, and may be connected to the same vacuum pump 6 as the distillation column (as in FIG. 1) or to a different vacuum pump. Feed material is introduced into the degassing chamber at a rate consistent with the processing capacity of the downstream distillation column. Under the influence of the vacuum in the vessel, the entrained gases and residual solvents escape from the feed material. The gases are evacuated by a vacuum pump, which is of a capacity sufficient to remove these vapors at the rate at which they are produced.

The inlet and outlet connections FIGS. 2, 8 and 9, respectively, for the feed material may be identical or more preferably different, in which latter case the degasser unit can only be installed in one direction in the system, making it less susceptible to operator error. In the latter case, the inlet and outlet connections may be differentiated by being of different sizes, fitted with different patterns of tabs that mesh with matching corresponding patterns on the connections to which they attach, or by any other suitable means. The inlet and outlet connections may be in close proximity to the port for connection of the vacuum system, but more preferably (as shown in FIG. 2) will be placed distant from it to avoid clogging the vacuum port with feed material. These feed connections and the vacuum port may equally preferably connect to like material (as for example, steel to steel) or to unlike material (as for example, glass to steel). Mechanical filters may be installed at the inlet or outlet connection, or both, to prevent particulates from entering the distillation column downstream of the degasser.

The geometry of the degassing vessel and its placement in the vacuum distillation system may preferably be such that it is self-draining and will not retain residual material in the vessel, as shown in FIGS. 1 and 2. One or more of the inlet and outlet connections for the feed material and the port for connection of the vacuum system may preferably be large enough to permit manual cleaning of the inside of the degassing chamber.

The degassing chamber of the invention may be heated. This may be done by providing around the feed lines or degassing chamber a hot oil jacket or electrical resistance heaters, or by some other means. The heated feed line or degassing chamber will impart heat to the feed material, enhancing the efficiency of the vaporization and separation of unwanted gases and solvents from the feed material.

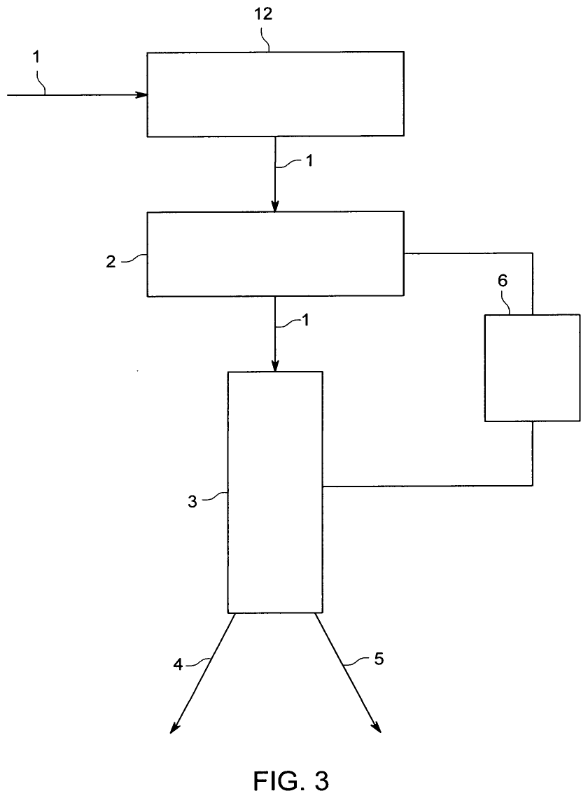

In another embodiment, the vacuum distillation system comprises an unheated degassing chamber and a preheater upstream of the degassing chamber, as shown in FIG. 3. The feed material 1 flows into the preheater vessel 12, which has an inlet and outlet for the feed material and a hot oil jacket, electric resistance heaters, or any other means of heating the vessel. It may but need not operate under vacuum. The preheater vessel is constructed of any suitable material rated for such service, preferably of stainless steel, aluminum, or glass.

Feed material is introduced into the preheater vessel, flows continuously through said vessel, which is of a volume and dimensions adequate to allow the feed material to be heated to the desired temperature as it passes through said vessel, and then exits said vessel to be introduced into the degassing chamber 2. Because no heating jacket or electrical resistance heaters are wrapped around the degasser vessel, this embodiment has the advantage, if the degassing vessel is made of glass, of leaving the operator's view of the material in the degasser unobstructed. Because the feed material is heated before it enters the degassing vessel, this embodiment also has the advantage of permitting a smaller degassing chamber than is the case when the feed material must be both heated and degassed within the same vessel. This increases the overall efficiency of the distillation system by reducing the volume of material that must be kept under vacuum. After leaving the degassing chamber, the feed material enters the distillation column 3 where it is separated into a distillate stream 4 and a residue stream 5. A vacuum pump 6 is connected to both the degassing unit and the distillation column, so that both operate under vacuum.

In another embodiment of the invention, the degassing chamber may be equipped with some mechanism for agitating the feed material flowing through it. Such agitation may promote the vaporization of entrained gases and residual solvents from the feed material. Such agitation may be accomplished by insertion of baffles, a stirring motor, ultrasonic pressure transducers, or any other means suited to the purpose.

Other advantages and other embodiments of the current invention will be obvious to those skilled in the art. Their omission here is not intended to exclude them from the claims advanced herein.

What is claimed is:

1. A continuous-feed vacuum distillation system comprising a distillation column, a degassing vessel, and one or more vacuum pumps, wherein
(i) the degassing vessel has at least one inlet and at least one outlet for feed material and at least one port for connection to a vacuum system; and
(ii) the degassing vessel operates under vacuum, and
(iii) the vacuum distillation system is arranged so that feed material flows continuously through the degasser vessel and then through the distillation column.

2. The vacuum distillation system of claim 1 comprising also a preheater vessel, wherein
(i) the preheater vessel has an inlet and outlet for feed material and does not operate under vacuum; and
(ii) the vacuum distillation system is arranged so that feed material flows continuously through the preheater vessel, then through the degasser vessel, and then through the distillation column.

3. The vacuum distillation system of claim 1 in which the degassing vessel is equipped with an agitator that operates on the feed material passing through said vessel.

4. A process for vacuum distillation in which the feed material flows continuously through a degassing vessel operating under vacuum prior to entering the distillation column.

5. The process of claim 4 in which the feed material flows continuously first through a preheater vessel before entering the degassing vessel.
